(19) United States
(12) Patent Application Publication
(10) Pub. No.: US 2013/0255564 A1
(43) Pub. Date: Oct. 3, 2013

(54) Dual Indicator Gauge

(71) Applicant: Donald Morse Swanson, Clarkston, MI (US)

(72) Inventor: Donald Morse Swanson, Clarkston, MI (US)

(73) Assignee: Numatics, Incorporated, Novi, MI (US)

(21) Appl. No.: 13/434,932

(22) Filed: Mar. 30, 2012

(51) Int. Cl. G01L 7/04; G01D 13/22; G01L 7/00; G01L 19/14

(52) U.S. Cl. 116/303; 116/200; 73/756; 73/732

(57) ABSTRACT

An indicator gauge has a housing with a front face and a sensor mounted in the housing. The front dial face has a first sensor indicator thereon for displaying an amount detected by the sensor. The housing has a side wall with a second sensor indicator shown thereon for displaying the amount detected by the sensor.

### TECHNICAL FIELD

The field of this invention relates to a gauge with dual indicators.

### BACKGROUND OF THE DISCLOSURE

An operator often looks at a gauge to monitor a parameter of a machine or system. Most gauges have a body with an indicator display for viewing. These gauges may be constructed for sensing and indicating temperature, liquid level, speed, gas pressure or some other parameter.

A problem with indicator displays on many gauges is that the display is accurately readable from a relatively narrow direction. Front facing dials are accurately read only when the operator is in front of the dial. However, there are many situations when the operator is not directly in front of the dial but may be around it or above it but still wants to obtain a quick reading of the gauge.

What is needed is dial that has dual indicator displays that are readable from different directions.

### SUMMARY OF THE DISCLOSURE

In accordance with one aspect of the invention, an indicator gauge has a housing, a front face and a sensor mounted in the housing. The front face has a first sensor indicator thereon for displaying an amount detected by the sensor. The housing also has a side wall with a second sensor indicator shown thereon for displaying the amount detected by the sensor.

Preferably, the sensor is a pressure sensor. The housing has a mounting stem extending rearwardly. The mounting stem includes a sensor pathway for passing pressure to the pressure sensor.

Desirably, the front face has pressure indicia marked thereon. A hand is moveably mounted with respect to the pressure indicia to indicate a pressure sensed by the pressure sensor.

Preferably, the side wall has a window therein. The sensor is operably connected to a side indicator dial that is arcuate in shape and that rotates with respect to the housing for displaying the amount detected by the sensor through the window.

Preferably, the hand and the side indicator dial are found on a single member such that the hand and side indicator dial pivot together about a common axis.

According to another aspect of the invention, a pressure gauge has a housing with a pressure sensor mounted therein and an inlet for operable connection to a pressure source for delivering pressure from the pressure source to the pressure sensor. The housing has a front dial face. A pivotable hand is connected to the pressure sensor for pivotable movement relative to the front dial face for indicating a pressure from a pressure source. The housing has a side wall generally perpendicular to the front face with a window therein. The pressure sensor is connected to a side indicator dial with pressure indicia thereon that rotates with respect to the body for showing the appropriate pressure indicia through the window.

Preferably, the pressure sensor is in the form of a Bourdon tube connected to one of the end dial face and the hand and also connected to the side indicator dial.

### BRIEF DESCRIPTION OF THE DRAWINGS

Reference now is made to the accompanying drawings in which:

FIG. 1 is a perspective view of a pressure gauge in accordance with one embodiment of the invention;

FIG. 2 is a front elevational view of the gauge shown in FIG. 1;

FIG. 3 is a top plan view of the gauge shown in FIG. 1;

FIG. 4 is a cross sectional view of the gauge taken along lines 4-4 as shown in FIG. 2;

FIG. 5 is a cross sectional view taken along the lines 5-5 as shown in FIG. 4;

FIG. 6 is an enlarged view taken along line 6 shown in FIG. 5;

FIG. 7 is a perspective view of the hand and side dial member.

### DETAILED DESCRIPTION OF THE PREFERRED EMBODIMENT

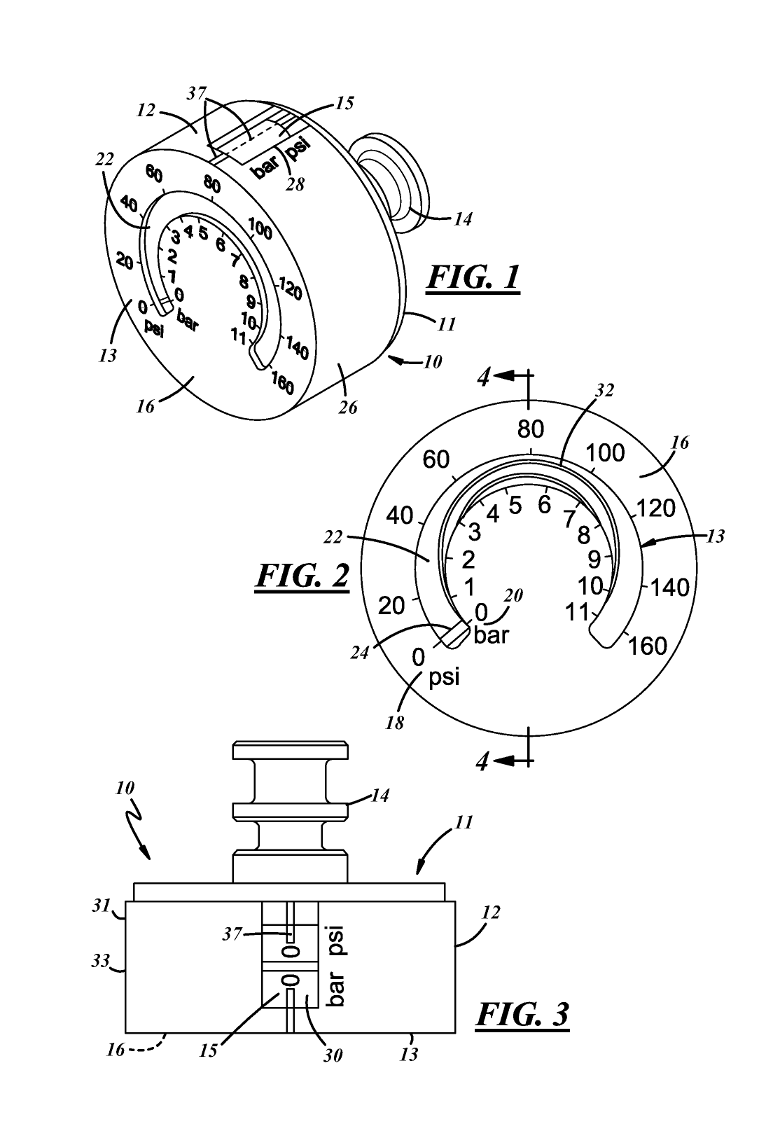

Referring now to FIGS. 1 and 2, a pressure gauge 10 has a housing 11 including a front shell 12 connected to inlet stem section 14 in a nesting fashion. The front shell 12 includes a first indicator 13 and a second indicator 15.

The first indicator 13 is on a front dial face 16 with appropriate indicia 18 and 20 for example PSI and Bar markings marked thereon. The dial face 16 also has an arcuate shaped transparent window 22. An indicator hand 24 is shown through the arcuate shaped transparent window 22.

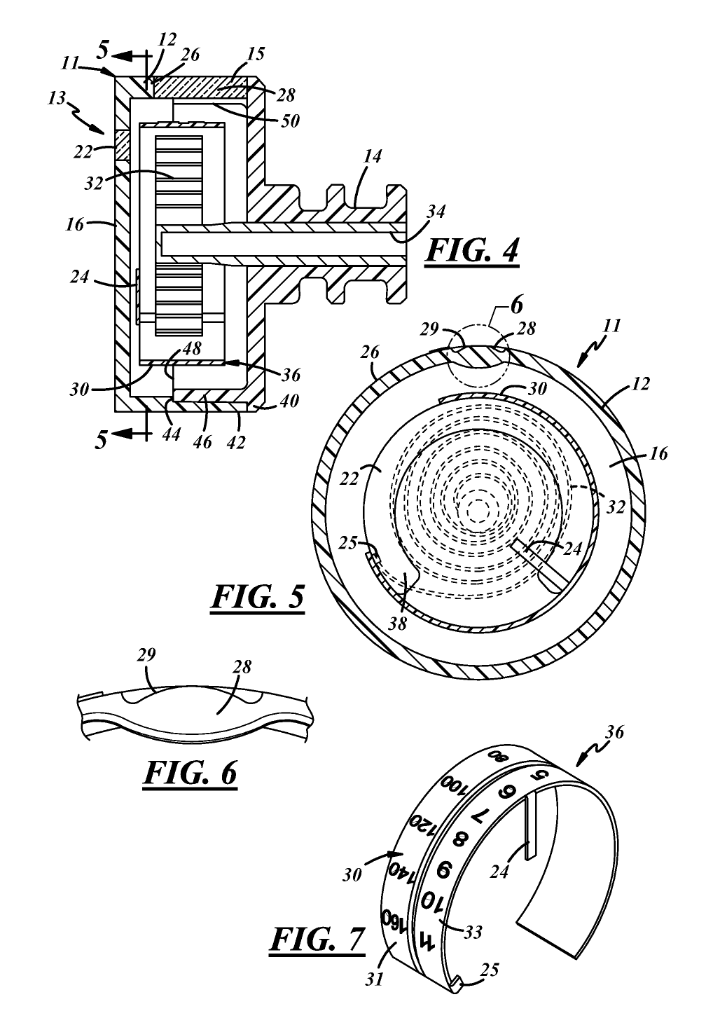

As shown more clearly in FIGS. 3 and 4, the second indicator 15 is on a cylindrical shaped side wall 26 of shell 10. The indicator 15 includes a transparent window 28 through the shell. The window 28 may be made from transparent glass or plastic material. The material may be shaped as more clearly seen in FIGS. 5 and 6 to provide a lens section 29 to magnify numbers or other indicia 31 and 33 marked on a side dial 30. Preferably, the magnifying effect of lens section 29 ranges from two to three times.

Referring now to FIGS. 4, 5, and 7, a hand and side dial member 36 has an integrally formed hand 24 and side dial 30. The hand and side dial member 36 is mounted for pivotable rotation within the shell 10 relative to the end dial face 16 and the side window 28. The hand and side dial member 36 is operably and fixedly connected to an end section 38 of Bourdon tube 32 that is spiral in shape. This connection may be via a fastener clip or sonic weld at tab 25, or other fastener (not shown). The Bourdon tube 32 is connected to center inlet tube 34 that passes through inlet stem section 14. The stem section 14 is then nested within the front shell 12. The stem section has an outer flange section 40 which seats against rear edge 42 of cylindrical side wall 26. Cylindrical shaped side wall 26 has an internal shoulder 44 that seats against stem section 14. More explicitly, stem section 14 has a nesting section 46 that fits within shell 12 and has a front edge 48 that abuts internal shoulder 44. The stem section 14 and main shell 12 may then be connected together via sonic welding, adhesive or alternatively by for example snap fit connectors. The stem section 14 may be opaque and have a slot 50 in nesting section 46 that is aligned under window 15 and lens section 28.

In operation, the gauge 10 has its inlet stem section operably mounted to a pressure source (not shown). The Bourdon tube 32 moves in response to pressure exerted therein which in turn pivots the hand and side dial member 36. The Bourdon tube 32 appropriately reacts to move in a predictive fashion to rotate the hand and side dial member 36 along a central axis. In other words, both the hand 26 and the side dial 30 rotate about the common axis. The hand 26 is then positioned to be seen aligned with the appropriate pressure indicia 18 and 20. In addition the side dial has its appropriate indicia 31 and 33 showing through window 28. An indicator line 37 is marked on window 22 for a more accurate reading. As shown, the multiple indicia 18 and 20 and side dial indicia 31 and 33 have multiple measuring units marked therein. For example, indicia 18 and 31 may be in PSI and indicia 20 and 33 may be in BAR units as shown in the preferred embodiment.

In this fashion, an operator may view the indicator pressure reading from either the front end dial face 16 or from cylindrical side wall 26 through window 28. The window 28 is preferably positioned facing upward but it may be positioned about the cylindrical shaped side wall 26 at other positions.

While a pressure gauge is shown, the dual indicator construction with the dial face 16 and side window 28 may be used for other types of gauges. Furthermore, while a cylindrical shaped side wall 26 is preferred, it is foreseen that the housing 11 may have other side wall configurations for example, a plurality of side walls forming a square or rectangle or other polygons or more complex configured shapes. While the preferred embodiment shows the hand mounted to the Bourdon tube and end face dial fixed to the housing, alternate embodiments are foreseen that have the end face dial mounted to the Bourdon tube and the hand affixed to the body. The dial indicia 18, 20, 31, and 33 may also be replaced with LCD or LED type digital displays.

Other variations and modifications are possible without departing from the scope and spirit of the present invention as defined by the appended claims.

The embodiments in which an exclusive property or privilege is claimed are defined as follows:

1. An indicator gauge comprising:
a housing with a main body with a front face;
a sensor mounted in said housing;
said front face with a first sensor indicator thereon for displaying an amount detected by said sensor; and
said housing having a side wall with a second sensor indicator shown thereon for displaying said amount detected by said sensor.

2. An indicator gauge a defined in claim 1 further comprising:
said sensor being a pressure sensor;
a mounting stem extending rearward from said main body; and
said mounting stem includes a sensor pathway for passing pressure to said pressure sensor.

3. An indicator gauge as defined in claim 2 further comprising:
said front face having pressure indicia marked thereon; and
a hand being pivotably mounted with respect to said pressure indicia to indicate a pressure sensed by said pressure sensor.

4. An indicator gauge as defined in claim 1 further comprising:
said front face having indicia marked therein; and
a hand being pivotably mounted with respect to said indicia for displaying said amount detected by said sensor.

5. An indicator gauge as defined in claim 4 further comprising:
said side wall having a window therein; and
said sensor operably connected to a side indicator dial that is arcuate in shape and that rotates with respect to said housing for displaying said amount detected by said sensor through said window.

6. An indicator gauge as defined in claim 5 further comprising:
said hand and said side indicator dial being on a single member such that the hand and said side indicator dial rotate together.

7. An indicator gauge as defined in claim 1 further comprising:
said side wall having a window therein; and
said sensor operably connected to a side indicator dial that is arcuate in shape and that rotates with respect to said body for displaying said amount detected by said sensor through said window.

8. A pressure gauge comprising:
a housing with a pressure sensor mounted therein and an inlet for operable connection to a pressure source for delivering pressure from said pressure source to said pressure sensor;
said housing having a front dial face and a pivotable hand connected to said pressure sensor for pivotable movement relative to said front dial face for indicating a pressure from said pressure source;
said housing having a side wall perpendicular to said front dial face with a window therein; and
said pressure sensor connected to a side dial indicator that rotates with respect to said body for indicating said pressure through said window.

9. A pressure gauge as defined in claim 8 further comprising:
said pressure sensor being a Bourdon tube connected to one of said front dial face and said hand and also connected to said side dial indicator.
